(19) United States
(12) Patent Application Publication
(10) Pub. No.: US 2012/0028128 A1
(43) Pub. Date: Feb. 2, 2012

(54) ALL-SOLID-STATE LITHIUM BATTERY

(75) Inventors: Yoshikatsu Seino, Sodegaura-shi (JP); Tadatoshi Murota, Kobe-shi (JP); Tetsu Fujiwara, Kobe-shi (JP)

(73) Assignee: SANTOKU CORPORATION, Kobe-shi, Hyogo (JP)

(21) Appl. No.: 13/257,219

(22) PCT Filed: Mar. 18, 2010
(86) PCT No.: PCT/JP2010/054664

§ 371 Date: Sep. 16, 2011

(30) Foreign Application Priority Data
Mar. 18, 2009 (JP) 209-066215
Mar. 18, 2009 (JP) 2009-066216

(51) Int. Cl. H01M 10/056; H01M 10/0562

(52) U.S. Cl. 429/304

(57) ABSTRACT

There is provided an all-solid lithium battery having excellent output characteristics. The battery has a cathode, an electrolyte layer, and an anode. The cathode contains a cathode active material represented by formula (1) and a sulfide solid electrolyte, and the electrolyte layer contains a sulfide solid electrolyte:

LiₐNi_{b}Co_{c}Mn_{d}MₑO_{f+σ} (1)

(1.01≦a≦1.05; f: 2 or 4; σ: not less than −0.2 and not more than 0.2; M: Mg, Ca, Y, rare earth elements, etc.; provided that when f=2, 0≦b≦1, 0≦c≦1, 0≦d≦1, 0≦e≦0.5, and b+c+d+e=1; when f=4, 0≦b≦2, 0≦c≦2, 0≦d≦2, 0≦e≦1, and b+c+d+e=2).

### FIELD OF ART

The present invention relates to all-solid lithium batteries.

### BACKGROUND ART

Lithium batteries, which contain a flammable organic solvent electrolyte, have an essential problem of risk to their safety, such as firing. The fundamental solution to this problem of safety is to use a nonflammable electrolyte in place of the flammable organic solvent electrolyte.

A typical example of such nonflammable electrolyte is a lithium ion-conductive solid electrolyte, which is inorganic. Use of an inorganic solid electrolyte not only results in improved safety, but also allows batteries to be made in the form of a thin film and integrated with electronic circuits, and improves reliability of batteries, such as cycle life and shelf life, due to ion selectivity of the inorganic solid electrolyte.

Capacity drop accompanying charge-discharge cycling as well as self-discharge of lithium batteries are often attributed to side reactions occurring inside the batteries. In lithium batteries, ions which contribute to the electrode reaction of the batteries are only lithium ions, and thus components other than lithium ions cause side reactions. For example, in lithium batteries with an organic solvent electrolyte, not only lithium ions, but also anions, solvent molecules, impurities, and the like migrate in the liquid electrolyte, and when dispersed over the cathode, which is strongly oxidizing, or the anode, which is strongly reducing, are oxidized or reduced to cause side reactions, which induces degradation of battery characteristics.

In contrast, in all-solid lithium batteries with an inorganic solid electrolyte, only lithium ions migrate in the inorganic solid electrolyte due to its ion selectivity. Thus, unlike in lithium batteries with an organic solvent electrolyte, side reactions caused by dispersion of the components other than lithium ions over the electrode surface will not continue. In this way, all-solid lithium batteries with an inorganic solid electrolyte enjoy long cycle life and low self-discharge.

However, all-solid lithium batteries have a drawback of lower output density achievable compared to the liquid electrolyte batteries.

In order to solve this problem, for example, there is proposed use of a carbon material, which has a low electrical potential and a high capacity density, as an anode material of all-solid lithium batteries (see Patent Publication 1). This may improve the energy density of all-solid lithium batteries, but the output density achievable is some hundred microamperes per square centimeter, which is still low compared to that achieved by liquid electrolyte batteries. In sum, all-solid lithium batteries have excellent reliability such as safety, but have generally low energy density or output density compared to lithium batteries with a liquid electrolyte.

### PATENT PUBLICATION

Patent Publication 1: International Publication WO2007/004590

### SUMMARY OF THE INVENTION

It is therefore an object of the present invention to provide all-solid lithium batteries having excellent output characteristics.

According to the present invention, there is provided an all-solid lithium battery comprising a cathode, an electrolyte layer, and an anode, said cathode comprising a cathode active material represented by the formula (1) and a sulfide solid electrolyte, and said electrolyte layer comprising a sulfide solid electrolyte:

LiₐNi_{b}Co_{c}Mn_{d}MₑO_{f+σ} (1)

wherein a is 1.01≦a≦1.05; f is 2 or 4; σ is not less than −0.2 and not more than 0.2; M stands for one or more elements selected from Mg, Ca, Y, rare earth elements, Ti, Zr, Hf, V, Nb, Ta, Cr, Mo, W, Fe, Cu, Ag, Zn, B, Al, Ga, C, Si, Sn, N, P, S, F, and Cl; provided that when f is 2, b is 0≦b≦1, c is 0≦c≦1, d is 0≦d≦1, e is 0≦e≦0.5, and b+c+d+e=1; when f is 4, b is 0≦b≦2, c is 0≦c≦2, d is 0≦d≦2, e is 0≦e≦1, and b+c+d+e=2.

The all-solid lithium battery of the present invention, which has the cathode and the electrolyte layer as described above, are excellent in safety and output characteristics, and thus may suitably be used as a power source for various electrical appliances.

### BRIEF DESCRIPTION OF THE DRAWINGS

FIG. 1 is a schematic sectional view of an embodiment of an all-solid lithium battery according to the present invention.

### PREFERRED EMBODIMENTS OF THE INVENTION

The present invention will now be explained in detail.

The all-solid lithium battery of the present invention has a cathode, an electrolyte layer, and an anode. The cathode contains a cathode active material represented by the formula (1) mentioned above and a sulfide solid electrolyte, and the electrolyte layer contains a sulfide solid electrolyte.

In the formula (1), a satisfies 1.01≦a≦1.05, preferably 1.01≦a≦1.04.

With a within the above range, the cathode active material of the present invention contains a lot of Li ions and has a stable crystal structure, which improves the battery characteristics.

The letter f denotes 2 or 4, provided that when f is 2, b is 0≦b≦1, c is 0≦c≦1, d is 0≦d≦1, e is 0≦e≦0.5, and b+c+d+e=1, whereas when f is 4, b is 0≦b≦2, c is 0≦c≦2, d is 0≦d≦2, e is 0≦e≦1, and b+c+d+e=2.

σ denotes a value decided depending on the contents of Li, Ni, Co., Mn, and M, and the kind of M, for balancing electric charge. σ is not less than −0.2 and not more than 0.2. For the sake of convenience, the value of σ will be described as 0 hereinbelow.

In the cathode active material of the present invention, M stands for one or more elements selected from Mg, Ca, Y, rare earth elements, Ti, Zr, Hf, V, Nb, Ta, Cr, Mo, W, Fe, Cu, Ag, Zn, B, Al, Ga, C, Si, Sn, N, P, S, F, and Cl. M is not a requisite, but may improve various battery characteristics when contained, and may be contained as inevitable impurities.

When M is Ti, the speed of deintercalation/intercalation of Li during charging/discharging is increased, which improves load characteristics. When M is Mg or Al, the crystal structure is stabilized, which improves thermal stability, and also the dispersion and reaction of Li upon synthesis of a cathode active material are promoted. When M is Zr or Hf, the crystal structure is stabilized, which enables charging/discharging at high potential.

When the cathode active material represented by the formula (1) (sometimes referred to as the present cathode active material hereinbelow) is, e.g., LiₐCoO₂, the battery performance may be improved. The reason for this is not clear, but, since LiₐCoO₂ contains more Li ions compared to LiCoO₂, is assumed to be ascribable to the facts that Li at the interface between LiₐCoO₂ and the sulfide solid electrolyte disperses smoothly, and that the crystallinity of LiₐCoO₂ is improved to increase the mechanical strength of the particles, so that the particles are hard to be collapsed during fabrication of an electrode.

However, when a is over 1.05, LiₐCoO₂ does not have a stable crystal structure, and may not be able to function as a cathode active material.

The present cathode active material may preferably be LiₐCoO_{2+σ}, LiₐNi_{0.8±0.1}Co_{0.15±0.1}Al_{0.05±0.05}O_{2+σ}, LiₐNi_{0.8±0.1}Co_{0.2±0.1}O_{2+σ}, LiₐNiO_{2+σ}, LiₐMn₂O_{4+σ}, LiₐMn_{0.5±0.1}Ni_{0.5±0.1}O_{2+σ}, LiₐMn_{1.5±0.1}Ni_{0.5±0.1}O_{4+σ}, LiₐMn_{0.33±0.1}Ni_{0.33±0.1}Co_{0.33±0.1}O_{2+σ}, or

### LiₐNi_{0.33±0.1}Co_{0.33±0.1}Mn_{0.33±0.1}Mg_{0.05±0.05}O_{2+σ}.

The specific surface area (BET surface area) of the present cathode active material is preferably 0.1 to 1.0 m²/g. This specific surface area may be measured, for example, by deaerating at 200° C. for 20 minutes the cathode active material to be measured, followed by N₂ adsorption BET method using NOVA2000 (manufactured by QUANTACHROME INDUSTRIES).

The present cathode active material has a tap density of usually not lower than 2.0 g/cm³, preferably not lower than 2.1 g/cm³, more preferably not lower than 2.15 g/cm³. The upper limit of the tap density is not particularly limited, but is usually 3.0 g/cm³, preferably about 2.6 g/cm³. Use of a cathode active material having such a tap density increases the contact area with the solid electrolyte, and improves the fluidity of the cathode active material particles, resulting in lower void when the cathode active material is made into a cathode mixture.

The tap density is measured by a method according to THE JAPANESE PHARMACOPEIA 15TH EDITION. Specifically, the cathode active material particles are tapped 200 times (twice/sec.) at 30 mm strokes, before subjected to the measurement of the density.

The cathode active material is preferably surface-modified with a lithium ion conductive oxide. Surface-modified particles have improved fluidity, resulting in improved tap density, which in turn improves the battery performance when used in batteries.

The lithium ion conductive oxide as a surface-modifying material may preferably be those having no electronic conductivity, such as crystalline oxides, including lithium titanate (Li_{4/3}Ti_{5/3}O₄), LiNbO₃, or LiTaO₃, or amorphous (glass) oxides, including Li₂O—SiO₂, with Li_{4/3}Ti_{5/3}O₄ being particularly preferred.

When surface-modified cathode active material particles are used, the above-mentioned tap density is that of the surface-modified particles. The same is applicable to the particle size and the like to be discussed below.

The surface-modification may be carried out with reference, for example, to the following article:
N. Ohta, K. Takada, L. Zhang, R. Ma, M. Osada, T. Sasaki, Adv. Mater. 18, 2226 (2005).

The particle size of the cathode active material (secondary particles D50) may preferably be 0.1 to 20 μm, more preferably 0.1 to 15 μm, still more preferably 0.1 to 10 μm. The particle size is measured by laser diffraction.

The cathode active material represented by the formula (1) wherein b=0 preferably contains secondary particles consisting of a plurality of primary particles, and/or single crystal grains, and A defined by the following formula (2) is not less than 1 and not more than 10:

A=(m+p)/(m+s) (2)

wherein m denotes the number of single crystal grains, s denotes the number of secondary particles, and p denotes the number of primary particles constituting the secondary particles.

The letter A represented by the formula (2) denotes the number of primary particles constituting a secondary particle of a cathode active material. With A being not less than 1 and not more than 10, the cathode active material particles have crystal grain-grown primary particles and secondary particles with smooth surface texture. The value represented by A is preferably not less than 2 and not more than 8.

The values represented by m, p, and s in the above formula (2) may be determined by embedding a plurality of cathode active material particles in a resin, mirror polishing the resulting sample, and observing the sample under a polarization microscope. More specifically, on a polarization micrograph of the sample (×1000), twenty of the secondary particles and/or single crystal grains are picked up at random. The number of the secondary particles out of twenty is denoted by s, and the number of the single crystal grains is denoted by m. Incidentally, single crystal grains are those having no grain boundaries observable under a polarization microscope mentioned above.

The number p of the primary particles may be determined by counting the number of the primary particles inside all the secondary particles observed in the above process and partitioned with grain boundaries. More specifically, the number p of the primary particles is the total number of the primary particles included in the cross-section of the secondary particles in the mirror finished surface.

The cathode active material of the present invention may be produced, for example, by the following method.

An aqueous solution of a cobalt compound, such as a cobalt sulfate aqueous solution or a cobalt nitrate aqueous solution, and an alkaline aqueous solution, such as a sodium hydroxide aqueous solution or an aqueous ammonia solution, are added to a reaction vessel under stirring and controlled temperature and pH, to thereby obtain cobalt hydroxide.

Here, for example, an ammonium salt, such as ammonium sulfate or ammonium nitrate, may be added as a complexing agent to the reaction vessel as required.

The resulting cobalt hydroxide is calcined at 300 to 850° C. for 1 to 24 hours to obtain cobalt oxide, to which lithium carbonate is added and mixed, and calcined at 850 to 1050° C. to obtain a cathode active material. The calcination may be performed by preliminary calcination at a temperature lower than the intended temperature, followed by raising up to the intended temperature.

The particle size, the shape, the particle size distribution, the tap density, and the like may be controlled by means of the concentration of the starting materials, for example, the concentration of the aqueous solutions for the synthesis of the raw oxides or hydroxides, the concentration of the alkaline aqueous solution, the addition rate, pH, the temperature, the conditions of calcination for the synthesis of the cathode active material from the obtained starting materials, the kind of lithium salt to be used, and the like factors. The ratio of the constituent elements of the cathode active material may be regulated by adjusting the mixing ratio of the starting materials.

The sulfide solid electrolyte in the cathode may be those consisting solely of sulfur, phosphorus, and lithium atoms, and may optionally contain Al, B, Si, Ge, and the like.

The sulfide solid electrolyte may preferably be produced from: (1) lithium sulfide (Li₂S) and phosphorous pentasulfide (P₂S₅), (2) lithium sulfide, elemental phosphorus, and elemental sulfur, or (3) lithium sulfide, phosphorous pentasulfide, elemental phosphorus, and elemental sulfur.

When the starting materials are lithium sulfide and phosphorus pentasulfide; or lithium sulfide, elemental phosphorus, and elemental sulfur, the mixing ratio by mole may usually be 50:50 to 80:20, preferably 60:40 to 75:25. A particularly preferred mixing ratio is about Li₂S:P₂S₅=70:30 (by mole).

The sulfide solid electrolyte may be produced, for example, by melting and reacting one of the mixtures (1) to (3) mentioned above and rapidly cooling, or mechanically milling one of the mixtures (1) to (3) (sometimes referred to as MM method hereinbelow), to obtain a glassy solid electrolyte, and further thermally treating the same into a crystalline solid electrolyte. More specifically, the sulfide solid electrolyte may be produced, for example, by a method disclosed in JP-2005-228570-A.

The average particle size of the sulfide solid electrolyte may preferably be 0.01 to 50 μm, more preferably 0.1 to 10 μm, more preferably 0.1 to 7 μm. The average particle size referred to herein is the average value (D50) measured by laser diffraction.

In the present invention, the cathode is made of a cathode mixture which is a mixture of a cathode active material and a sulfide solid electrolyte.

The mixing ratio of the cathode active material and the sulfide solid electrolyte in the cathode mixture may preferably be cathode active material:electrolyte=95:5 to 50:50 (by mass).

In the cathode mixture, the particle size of the cathode active material particles may preferably be not smaller than 1 μm and not larger than 10 μm, the specific surface area of the cathode active material particles may preferably be not less than 0.20 m²/g and not more than 0.8 m²/g, and the particle size of the sulfide solid electrolyte may preferably be 0.01 to 50 μm. It is more preferred that the cathode active material particles have a particle size of not smaller than 4.2 μm and not larger than 7.0 μm, and the specific surface area of not less than 0.35 m²/g and not more than 0.7 m²/g.

The above conditions imply that the cathode active material particles of the present invention have a smaller particle size than ordinary ones.

In the present invention, the sulfide solid electrolyte contained in the electrolyte layer may be similar to the sulfide solid electrolyte contained in the cathode discussed above.

The sulfide solid electrolyte in the electrolyte layer may be the same or different from the sulfide solid electrolyte in the cathode, and preferably the same as that in the cathode.

The all-solid lithium battery according to the present invention is composed, for example, of a cathode containing the cathode active material of the present invention and a sulfide solid electrolyte; an anode; and an electrolyte layer held between the cathode and the anode and containing a sulfide solid electrolyte.

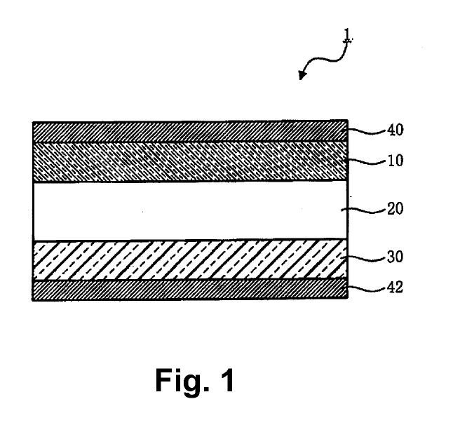

FIG. 1 is a schematic cross-sectional view showing an embodiment of the all-solid lithium battery according to the present invention.

All-solid lithium battery 1 is composed of a laminate of cathode 10, solid electrolyte layer 20, and anode 30 overlaid in this order, which laminate is held between cathode collector 40 and anode collector 42.

The cathode 10 is composed of a cathode mixture which is a mixture of the cathode active material and the sulfide solid electrolyte discussed above, and the solid electrolyte layer 20 is composed of the sulfide solid electrolyte discussed above.

The anode 30 is not particularly limited as long as it is usable as a battery anode. For example, the anode 30 may be made of an anode mixture which is a mixture of an anode active material and a solid electrolyte, or a carbon anode.

The anode active material may be any commercial anode active material without particular limitation, and may preferably be carbon materials, Sn metal, Si metal, Li metal, In metal, and the like.

Specific examples of the anode active material may include natural graphite, various kinds of graphite, powders of metal, such as Sn, Si, Al, Sb, Zn, or Bi; powders of metal alloys, such as Sn₅Cu₆, Sn₂Co, Sn₂Fe, TiSi alloys, NiSi alloys, or Li alloys; powders of metal oxides, such as Si oxide; other amorphous alloys; or plating alloys.

The particle size of the anode active material is not particularly limited, and the average particle size may preferably be some micrometers to 80 μm.

The solid electrolyte in the anode 30 may be, for example, the sulfide solid electrolyte for the cathode 10.

The anode mixture may be prepared by mixing the anode active material and the solid electrolyte discussed above at a particular ratio.

The cathode collector 40 and the anode collector 42 may be made of, for example, metals, such as stainless steel, gold, platinum, zinc, nickel, tin, aluminum, molybdenum, niobium, tantalum, tungsten, or titanium; or alloys thereof.

The collectors may be prepared by forming these metals or alloys into a sheet, foil, mesh, punched metal, or expanded metal.

According to the present invention, it is preferred for current collectability, processability, and costs that the cathode collector 40 is made of aluminum foil, and the anode collector 42 is made of aluminum or tin foil.

The all-solid lithium battery 1 may be fabricated by, for example, preparing in advance a composite cathode sheet composed of a laminate of cathode 10 and cathode collector 40, a composite anode sheet composed of a laminate of anode 30 and anode collector 42, and a sheet of solid electrolyte 20, and overlaying these sheets one on another, and pressing.

The composite cathode sheet and the composite anode sheet may be prepared, for example, by forming a film of cathode 10 or anode 30 over at least part of cathode collector 40 or anode collector 42, respectively. The film may be formed by blasting, aerosol deposition, cold spraying, sputtering, vapor growth, or thermal spraying.

The composite cathode sheet and the composite anode sheet may alternatively be prepared by slurrying a composite electrode material for cathode 10 or anode 30 (cathode mixture or anode mixture, respectively), applying a solution of the composite electrode material on cathode collector 40 or anode collector 42, respectively, or laminating the composite electrode material for cathode 10 or anode 30 on cathode collector 40 or anode collector 42, respectively, followed by pressing.

Further, the all-solid lithium battery 1 may also be prepared by forming a laminate of cathode collector 40, cathode 10, and electrolyte layer 20 overlaid in this order, separately forming a laminate of anode collector 42 and anode 30 overlaid in this order, and overlaying the laminates one on another so that the electrolyte layer 20 is in contact with the anode 30.

### EXAMPLES

The present invention will now be explained in more detail with reference to Examples, which are not intended to limit the present invention.

### Example 1-1

### Synthesis of Cathode Active Material

Cobalt metal in the amount of 100 g was dissolved in nitric acid, and diluted with pure water to be in the amount of 1650 ml. Then 820 ml of 4N sodium hydroxide solution was added, and the resulting mixture was stirred and filtered to obtain a cake of hydroxide. This cake was calcined at 850° C. for 4 hours to obtain 137 g of cobalt oxide. Lithium carbonate (Li₂CO₃) was added to the thus obtained cobalt oxide at Li/Co=1.02, mixed, and calcined preliminarily at 700° C. for 4 hours, then at 1000° C. for 5 hours to obtain an objective LiₓCoO₂ (x=1.02). The following measurements were made, and the results are shown in Table 1.

### (A) Particle Size

The particle size was measured with a laser diffraction particle size analyzer (MASTERSIZER 2000 manufactured by SYSMEX CORPORATION).

### (B) Specific Surface Area (BET Surface Area)

The specific surface area was measured by N₂ adsorption BET method in “NOVA 2000” (trade name, manufactured by QUANTACHROME INSTRUMENTS), following deaeration of a sample at 200° C. for 20 minutes.

### [Preparation of Sulfide Solid Electrolyte]

High purity lithium sulfide in the amount of 0.6508 g (0.01417 mol) and phosphorous pentasulfide in the amount of 1.3492 g (0.00607 mol) were thoroughly mixed, and the resulting mixed powder was introduced into an aluminum pot and sealed completely. The pot with the mixed powder was attached to a planetary ball mill, and subjected to milling in low-speed rotation (85 rpm) first for a few minutes for thoroughly mixing the starting materials. Then the rotation speed was gradually increased to 370 rpm, and mechanical milling was carried out for 20 hours. The obtained powder was confirmed by X-ray determination to be vitrified, and then thermally treated at 300° C. for 2 hours to obtain a sulfide solid electrolyte.

The ion conductivity of the obtained sulfide solid electrolyte was determined by AC impedance analysis (measured at 100 Hz to 15 MHz), and found to be 1.0×10⁻³ S/cm at room temperature. The average particle size of the sulfide solid electrolyte particles was 5 μm.

### [Preparation of Cathode Mixture]

The cathode active material LiₓCoO₂ (x=1.02) synthesized above and the sulfide solid electrolyte prepared above were mixed so that the sulfide solid electrolyte was at 30 mass %, to thereby obtain a cathode mixture.

### [Fabrication of All-Solid Lithium Battery]

The sulfide solid electrolyte prepared above in the amount of 50 mg was introduced into a plastic cylinder of 10 mm diameter, and subjected to pressing, and then the cathode mixture prepared above (cathode active material: LiₓCoO₂ (x=1.02)) in the amount of 30 mg was introduced, and subjected to pressing.

From the side of the cylinder opposite to the cathode mixture, indium foil (0.1 mm thick, 9 mm φ) was introduced to complete a three-layered structure of the cathode, the solid electrolyte layer, and the anode, to thereby obtain an all-solid lithium battery.

The all-solid lithium battery thus fabricated was charged at 500 μA per 1 cm² up to 3.9 V, and then discharged at a discharge current density of 10 mA/cm², to evaluate the discharge capacity and the discharge voltage. The results are shown in Table 1.

### Example 1-2

An all-solid lithium battery was prepared and evaluated in the same way as in Example 1-1, except that, in the synthesis of the cathode active material, lithium carbonate (Li₂CO₃) was added at Li/Co=1.04 to synthesize LiₓCoO₂ (x=1.04), with which a cathode mixture was prepared. The results are shown in Table 1.

### Example 1-3

An all-solid lithium battery was prepared and evaluated in the same way as in Example 1-1, except that, in the synthesis of the cathode active material, lithium carbonate (Li₂CO₃) was added at Li/Co=1.01 to synthesize LiₓCoO₂ (x=1.01), with which a cathode mixture was prepared. The results are shown in Table 1.

### Example 1-4

An all-solid lithium battery was prepared and evaluated in the same way as in Example 1-1, except that, in the synthesis of the cathode active material, lithium carbonate (Li₂CO₃) was added at Li/Co=1.03 to synthesize LiₓCoO₂ (x=1.03), with which a cathode mixture was prepared. The results are shown in Table 1.

### Example 1-5

### Preparation of Anode Mixture

An anode mixture was prepared by mixing graphite (particle size: D50=25 μm) and the sulfide solid electrolyte prepared in Example 1-1 at a ratio of graphite:sulfide solid electrolyte=6:4 (by mass).

### [Fabrication of All-solid Lithium Battery]

An all-solid lithium battery was prepared and evaluated in the same way as in Example 1-1, except that the indium foil was replaced with 8.8 mg of the anode mixture prepared above, and the cathode mixture prepared in Example 1-1 was used in the amount of 14.4 mg. The results are shown in Table 1.

### Example 1-6

An all-solid lithium battery was prepared and evaluated in the same way as in Example 1-2, except that the indium foil was replaced with 8.8 mg of the anode mixture prepared in Example 1-5, and the cathode mixture prepared in Example 1-2 was used in the amount of 14.4 mg. The results are shown in Table 1.

### Example 1-7

For synthesizing a cathode active material, 34 g of nickel metal, 33 g of cobalt metal, and 33 g of manganese metal were dissolved in nitric acid, and diluted with pure water to be in the amount of 1650 ml. Then 820 ml of 4N sodium hydroxide solution was added, and the resulting mixture was stirred and filtered to obtain a cake of hydroxide. This cake was dried at 100° C. for 10 hours to obtain 165 g of nickel-cobalt-manganese composite hydroxide.

Lithium hydroxide hydrate (LiOH.H₂O) was added to the thus obtained composite hydroxide at Li/(Ni+Co+Mn)=1.03, mixed, and calcined at 900° C. to synthesize Liₓ(Ni₀₃₄Co_{0.33}Mn_{0.33})O₂ (x=1.03). An all-solid lithium battery was prepared and evaluated in the same way as in Example 1-1, except that the cathode mixture was prepared with the thus obtained cathode active material. The results are shown in Table 1.

### Example 1-8

For synthesizing a cathode active material, 34 g of nickel metal, 33 g of cobalt metal, 30 of manganese metal, and 3 g of magnesium metal were dissolved in nitric acid, and diluted with pure water to be in the amount of 1650 ml. Then 820 ml of 4N sodium hydroxide solution was added, and the resulting mixture was stirred and filtered to obtain a cake of hydroxide. This cake was dried at 100° C. for 10 hours to obtain 164 g of nickel-cobalt-manganese-magnesium composite hydroxide.

Lithium hydroxide hydrate (LiOH.H₂O) was added to the thus obtained composite hydroxide at Li/(Ni+Co)=1.03, mixed, and calcined at 900° C. to synthesize Liₓ(Ni_{0.34}Co_{0.33}Mn_{0.30}Mg_{0.03})O₂ (x=1.03). An all-solid lithium battery was prepared and evaluated in the same way as in Example 1-1, except that the cathode mixture was prepared with the thus obtained cathode active material. The results are shown in Table 1.

### Example 1-9

For synthesizing a cathode active material, 85 g of nickel metal and 15 g of cobalt metal were dissolved in nitric acid, and diluted with pure water to be in the amount of 1650 ml. Then 820 ml of 4N sodium hydroxide solution was added, and the resulting mixture was stirred and filtered to obtain a cake of hydroxide. This cake was dried at 100° C. for 10 hours to obtain 166 g of nickel-cobalt composite hydroxide.

Lithium hydroxide hydrate (LiOH.H₂O) was added to the thus obtained nickel-cobalt composite hydroxide at Li/(Ni+Co)=1.03, mixed, and calcined at 800° C. to synthesize Liₓ(Ni_{0.85}Co_{0.15})O₂ (x=1.03). An all-solid lithium battery was prepared in the same way as in Example 1-1, except that the cathode mixture was prepared with the thus obtained cathode active material. The obtained all-solid lithium battery was charged at 500 μA per 1 cm² up to 3.6 V, and then discharged at a discharge current density of 10 mA/cm², to evaluate the discharge capacity and the discharge voltage. The results are shown in Table 1.

### Example 1-10

For synthesizing a cathode active material, 85 g of nickel metal and 15 g of cobalt metal were dissolved in nitric acid, and diluted with pure water to be in the amount of 1650 ml. Then 820 ml of 4N sodium hydroxide solution and 40 ml of 1 mol/l aluminum nitrate solution were added, and the resulting mixture was stirred and filtered to obtain a cake of hydroxide. This cake was dried at 100° C. for 10 hours to obtain 168 g of nickel-cobalt composite hydroxide.

Lithium hydroxide hydrate (LiOH.H₂O) was added to the thus obtained composite hydroxide at Li/(Ni+Co+Al)=1.03, mixed, and calcined at 800° C. to synthesize Liₓ (Ni_{0.82}Co_{0.14}Al_{0.04})O₂ (x=1.03). An all-solid lithium battery was prepared and evaluated in the same way as in Example 1-9, except that the cathode mixture was prepared with the thus obtained cathode active material. The results are shown in Table 1.

### Comparative Example 1-1

An all-solid lithium battery was prepared and evaluated in the same way as in Example 1-1, except that, in the synthesis of the cathode active material, lithium carbonate (Li₂CO₃) was added at Li/Co=1.00 to synthesize LiₓCoO₂ (x=1.00), with which a cathode mixture was prepared. The results are shown in Table 1.

### Comparative Example 1-2

An all-solid lithium battery was prepared and evaluated in the same way as in Example 1-1, except that, in the synthesis of the cathode active material, lithium carbonate (Li₂CO₃) was added at Li/Co=1.06 to synthesize LiₓCoO₂ (x=1.06), with which a cathode mixture was prepared. The results are shown in Table 1.

TABLE 1

| | | | | Average | | Specific | | |
|---|---|---|---|---|---|---|---|---|
| | | | Discharge | number A | Tap | surface | Particle | Discharge |
| | | | Capacity | represented by | density | area | size D50 | Voltage |
| | Anode | Cathode | (mAh/g)*¹ | formula (2) | (g/cm³)*³ | (m²/g) | (μm) | (V)*² |
| Ex. 1-1 | In | Li₁₀₂CoO₂ | 110 | 4.6 | 2.289 | 0.42 | 6.87 | 2.6 |
| Ex. 1-2 | In | Li₁₀₄CoO₂ | 100 | 3.6 | 2.294 | 0.34 | 7.21 | 2.5 |
| Ex. 1-3 | In | Li₁₀₁CoO₂ | 95 | 6.5 | 2.105 | 0.53 | 5.07 | 2.5 |
| Ex. 1-4 | In | Li₁₀₃CoO₂ | 90 | 4.2 | 2.205 | 0.4 | 6.98 | 2.4 |
| Ex. 1-5 | C | Li₁₀₂CoO₂ | 105 | 4.6 | 2.289 | 0.42 | 6.87 | 3.0 |
| Ex. 1-6 | C | Li₁₀₄CoO₂ | 95 | 3.6 | 2.294 | 0.34 | 7.21 | 2.9 |
| Ex. 1-7 | In | Li₁₀₃(Ni₀₃₄Co₀₃₃Mn₀₃₃)O₂ | 95 | 14.3 | 2.153 | 0.32 | 8.99 | 2.5 |
| Ex. 1-8 | In | Li₁₀₃(Ni₀₃₄Co₀₃₃Mn₀₃₀Mg₀₀₃)O₂ | 90 | 15.2 | 2.253 | 0.29 | 8.43 | 2.5 |
| Ex. 1-9 | In | Li₁₀₃(Ni₀₃₅Co₀₁₅)O₂ | 125 | 70 | 2.052 | 0.24 | 9.28 | 2.4 |
| Ex. 1-10 | In | Li₁₀₃(Ni₀₃₂Co₀₁₄Al₀₀₄)O₂ | 120 | 90 | 2.012 | 0.25 | 9.10 | 2.4 |
| Comp. Ex. 1-1 | In | LiCoO₂ | 0 | 20 | 1.677 | 0.72 | 4.69 | 0 |
| Comp. Ex. 1-2 | In | Li₁₀₆CoO₂ | 40 | 3.1 | 2.196 | 0.21 | 12.5 | 2.2 |

*¹Based on cathode active material
*²Potential at 50% discharge
*³Density after tapping 200 times (twice/sec.) was measured with MULTI TESTER MT-1001 manufactured by SEISHIN ENTERPRISE CO., LTD. The tapping stroke was 30 mm.

### Example 2-1

### Synthesis of Cathode Active Material

Cobalt oxide having a particle size of 7 μm (D50) and lithium carbonate were mixed homogeneously, calcined at 700° C. for 4 hours, and then at 1000° C. for 5 hours. The resulting oxide particles were subjected to composition analysis by ICP, and revealed to be LiₓCoO₂ particles having a Li/Co ratio of 1.01:1.00. The particle size of the obtained LiₓCoO₂ was 7.00 μm (D50), and the specific surface area was 0.46 m²/g. The measurements were made as follows:

### (A) Particle Size

The particle size was measured with a laser diffraction particle size analyzer (MASTERSIZER 2000 manufactured by SYSMEX CORPORATION).

### (B) Specific Surface Area (BET Surface Area)

The specific surface area was measured by N₂ adsorption BET method in “NOVA 2000” (trade name, manufactured by QUANTACHROME INSTRUMENTS), following deaeration of a sample at 200° C. for 20 minutes.

A sulfide solid electrolyte was prepared in the same way as in Example 1-1.

### [Preparation of Cathode Mixture]

The cathode active material and the sulfide solid electrolyte prepared above were mixed so that the sulfide solid electrolyte was at 30 mass %, to thereby obtain a cathode mixture.

### [Fabrication of All-Solid Lithium Battery]

The sulfide solid electrolyte prepared above in the amount of 50 mg was introduced into a plastic cylinder of 10 mm diameter, and pressed at 1.7 t/cm², to prepare a solid electrolyte layer.

Then into the cylinder with the solid electrolyte layer, 30 mg of the cathode mixture prepared above was introduced, and pressed at 5 t/cm², to prepare a laminate of a solid electrolyte layer and a cathode.

Next, on the solid electrolyte layer side of the laminate, indium foil (0.1 mm thick, 9 mm φ) was formed, to complete an all-solid lithium battery having a three-layered structure of the cathode, the solid electrolyte layer, and the anode.

The all-solid lithium battery thus fabricated was charged at 500 μA per 1 cm² up to 3.9 V, and then discharged at a discharge current density of 10 mA/cm², to evaluate the discharge capacity and the discharge voltage. The results are shown in Table 2.

### Example 2-2

The cathode active material prepared in Example 2-1 was surface-modified with Li_{4/3}Ti_{5/3}O₄ in accordance with the method disclosed in N. Ohta, K. Takada, L. Zhang, R. Ma, M. Osada, T. Sasaki, Adv. Mater. 18, 2226 (2005).

The surface-modified cathode active material had a particle size of 7.20 μm (D50), and a specific surface area of 0.44 m²/g. A cathode mixture was prepared and an all-solid lithium battery was prepared and evaluated in the same way as in Example 2-1, except that the cathode active material particles thus obtained were used. The results are shown in Table 2.

### Example 2-3

An all-solid lithium battery was prepared and evaluated in the same way as in Example 2-2, except that the indium foil was replaced with an anode made of the following anode mixture in accordance with the following method. The results are shown in Table 2.

### [Anode Mixture]

An anode mixture was prepared by mixing graphite (particle size: D50=25 μm) and the sulfide solid electrolyte particles prepared above at a ratio of graphite:sulfide solid electrolyte particles=6:4 (by mass).

An all-solid lithium battery was prepared in the same way as in Example 2-1, except that 8.8 mg of the thus obtained anode mixture was used and the cathode mixture prepared in Example 2-1 was used in the amount of 14.4 mg.

Incidentally, the anode was formed by introducing the anode mixture into a plastic cylinder, and pressing at 1.7 t/cm², and the solid electrolyte layer was formed by introducing 50 mg of the sulfide solid electrolyte onto the anode, and pressing at 3.4 t/cm². Then into the cylinder with the solid electrolyte layer, 30 mg of the cathode mixture was introduced, and pressed at 5 t/cm².

### Comparative Example 2-1

A cathode mixture was prepared and an all-solid lithium battery was prepared and evaluated in the same way as in Example 2-1, except that the cathode active material particles prepared by the following method was used. The results are shown in Table 2.

### [Preparation of Cathode Active Material Particles]

Cobalt oxide having a particle size of 13 μm (D50) and lithium carbonate were mixed homogeneously, calcined at 700° C. for 4 hours, and then at 750° C. for 5 hours. The resulting oxide particles were subjected to composition analysis by ICP, and revealed to be LiₓCoO₂ particles having a Li/Co ratio of 0.99:1.00. The particle size of the obtained cathode active material was 12.50 μm (D50), and the specific surface area was 0.85 m²/g.

### Comparative Example 2-2

A cathode mixture was prepared and an all-solid lithium battery was prepared and evaluated in the same way as in Example 2-1, except that LiCoO₂ particles (CELLSEED C-10 manufactured by NIPPON CHEMICAL INDUSTRIAL CO., LTD.) were used. The results are shown in Table 2.

### Comparative Example 2-3

A cathode mixture was prepared and an all-solid lithium battery was prepared and evaluated in the same way as in Example 2-3, except that the cathode active material particles as used in Comparative Example 2-1 were used. The results are shown in Table 2.

### Comparative Example 2-4

A cathode mixture was prepared and an all-solid lithium battery was prepared and evaluated in the same way as in Example 2-3, except that the LiCoO₂ particles as used in Comparative Example 2-2 were used. The results are shown in Table 2.

### Comparative Example 2-5

A cathode mixture was prepared and an all-solid lithium battery was prepared and evaluated in the same way as in Example 2-1, except that the LiCoO₂ particles as used in Comparative Example 2-2 were used, and the final pressing pressure in the fabrication of the battery was 7 t/cm². The results are shown in Table 2.

Since the batteries prepared in Comparative Examples 2-1 to 2-4 did not function as batteries as shown in Table 2, the pressure for pressing was raised in this Comparative Example, but the obtained battery did not function as a battery, either.

TABLE 2

| | | | | | | Tap density |
|---|---|---|---|---|---|---|
| | | | | | Average | of cathode |
| | | Cathode | Discharge | Discharge | number A | active |
| | | active | Capacity | Voltage | represented | material |
| | Anode | material | (mAh/g)*¹ | (V)*² | by formula (2) | (g/cm³)*³ |
| Ex. 2-1 | In foil | Li₁₀₁CoO₂ | 85 | 2.4 | 3.6 | 2.105 |
| Ex. 2-2 | In foil | Li₁₀₁CoO₂ | 90 | 2.5 | 3.6 | 2.384 |
| Ex. 2-3 | Anode | Li₁₀₁CoO₂ | 95 | 2.9 | 3.6 | 2.384 |
| | mixture | | | | | |
| Comp. Ex. 2-1 | In foil | Li₀₉₉CoO₂ | 0 | 0 | 20.3 | 1.667 |
| Comp. Ex. 2-2 | In foil | LiCoO₂ | 0 | 0 | 11.2 | 1.986 |
| Comp. Ex. 2-3 | Anode | Li₀₉₉CoO₂ | 0 | 0 | 20.3 | 1.667 |
| | mixture | | | | | |
| Comp. Ex. 2-4 | Anode | LiCoO₂ | 0 | 0 | 11.2 | 1.986 |
| | mixture | | | | | |
| Comp. Ex. 2-5 | In foil | LiCoO₂ | 0 | 0 | 11.2 | 1.667 |

*¹Based on cathode active material
*²Potential at 50% discharge
*³Density after tapping 200 times (twice/sec.) was measured with MULTI TESTER MT-1001 manufactured by SEISHIN ENTERPRISE CO., LTD. The tapping stroke was 30 mm.

### INDUSTRIAL APPLICABILITY

The all-solid lithium battery of the present invention may be used as a lithium battery used in personal digital assistances, personal electronic devices, home power storage units, automatic motorcycles having a motor as a power source, electric vehicles, hybrid electric vehicles, and the like.

### DESCRIPTION OF REFERENCE NUMERALS

1 all-solid lithium battery
1 cathode
20 electrolyte layer
30 anode
40 cathode collector
42 anode collector

1. An all-solid lithium battery comprising a cathode, an electrolyte layer, and an anode,
said cathode comprising a cathode active material represented by the formula (1) and a sulfide solid electrolyte, and said electrolyte layer comprising a sulfide solid electrolyte:
LiₐNi_{b}Co_{c}Mn_{d}MₑO_{f+σ} (1)
wherein a is 1.01≦a≦1.05; f is 2 or 4; a is not less than −0.2 and not more than 0.2; M stands for one or more elements selected from Mg, Ca, Y, rare earth elements, Ti, Zr, Hf, V, Nb, Ta, Cr, Mo, W, Fe, Cu, Ag, Zn, B, Al, Ga, C, Si, Sn, N, P, S, F, and Cl; provided that when f is 2, b is 0≦b≦1, c is 0≦c≦1, d is 0≦d≦1, e is 0≦e≦0.5, and b+c+d+e=1; when f is 4, b is 0≦b≦2, c is 0≦c≦2, d is 0≦d≦2, e is 0≦e≦1, and b+c+d+e=2.

2. The all-solid lithium battery according to claim 1, wherein said cathode active material is LiₐCoO_{2+σ}, LiₐNi_{0.8±0.1}Co_{0.15±0.1}Al_{0.05±0.05}O_{2+σ}, LiₐNi_{0.8±0.1}Co_{0.2±0.1}O_{2+σ}, LiₐNiO_{2+σ}, LiₐMn₂O_{4+σ}, LiₐMn_{0.5±0.1}Ni_{0.5±0.1}O_{2+σ}, LiₐMn_{1.5±0.1}Ni_{0.5±0.1}O_{4+σ}, LiₐMn_{0.33±0.1}Ni_{0.33±0.1}Co_{0.33±0.1}O_{2+σ}, or LiₐNi_{0.33±0.1}Co_{0.33±0.1}Mn_{0.33±0.1}Mg_{0.05±0.05}O_{2+σ}.

3. The all-solid lithium battery according to claim 1 or 2 claim 1, wherein a is 1.01≦a≦1.04.

4. The all-solid lithium battery according to claim 1, wherein a tap density of said cathode active material represented by the formula (1) is not lower than 2.0 g/cm³.

5. The all-solid lithium battery according to claim 1, wherein said cathode active material represented by the formula (1) has been surface-modified with a lithium ion conductive oxide.

6. The all-solid lithium battery according to claim 1, wherein said cathode active material represented by the formula (1) has a particle size of not smaller than 1 μm and not larger than 10 μm, and a specific surface area of not less than 0.20 m²/g and not more than 0.8 m²/g, and said sulfide solid electrolyte has a particle size of not smaller than 0.01 μm and not larger than 50 μm.

7. The all-solid lithium battery according to claim 1, wherein said cathode active material represented by the formula (1) has a particle size of not smaller than 4.2 μm and not larger than 7.0 μm, and a specific surface area of not less than 0.35 m²/g and not more than 0.7 m²/g.

8. The all-solid lithium battery according to claim 1, wherein said cathode active material represented by the formula (1) wherein b=0 comprises secondary particles consisting of a plurality of primary particles, and/or single crystal grains, and wherein A represented by formula (2) is not less than 1 and not more than 10:
A=(m+p)/(m+s) (2)
wherein m denotes the number of single crystal grains, s denotes the number of secondary particles, and p denotes the number of primary particles constituting the secondary particles.
